(19) United States
(12) Patent Application Publication
(10) Pub. No.: US 2007/0001442 A1
(43) Pub. Date: Jan. 4, 2007

(54) Safely assistant wheel structure of a power-driven wheelchair

(76) Inventor: Chien-Liang Chiu, Hsin-Chu (TW)

Correspondence Address: DEBORAH A. BARNES, 3582 SILVERLACE LANE #34, BOYNTON BEACH, FL, 33436, US

(21) Appl. No.: 11/169,005

(22) Filed: Jun. 29, 2005

(51) Int. Cl. B62D 49/08; B60G 3/20

(52) U.S. Cl. 280/755; 280/124.104; 180/907

(57) ABSTRACT

A safely assistant wheel structure of a power-driven wheelchair having a body under which a front wheel and a rear wheel are provided, in which a front end of the front wheel is provided with an assistant wheel of which an axle center is provided for a holder to stretch through above which a fixed link is provided stretching from the body, and a shock absorber spring is provided between the holder and the fixed link, when the forward moving power-driven wheelchair is suddenly braked, an inertial, a forward leaning force of the body is eliminated by the assistant wheel and detracted by the spring for the stability of wheelchair body and the safe ride of a rider.

### BACKGROUND OF THE INVENTION

1. Field of the Invention

This invention relates to a safely assistant wheel structure of a power-driven wheelchair and particularly to an improved structure of a power-driven wheelchair that effectively disperses inertial effect, for the balance of body, caused when making a stop and thus makes a user safely rides.

2. Description of the Prior Art

In the modern society, aging is a natural trend in the world. Due to degenerate physiological function, old people have poor capability in action and reaction, and thus the power-driven wheelchair is provided to assist them in life. Therefore, the marketing of power-driven wheelchair has gone extremely increasing in recently years and this product has been valued in all developed countries.

The power-driven wheelchair serves only for a ride instead of walk and its fast move design is not considered, so there are lower requirements of the wheelchair structure in design for reduction of production costs. However, because the wheelchair serves for the ride instead of walk, the old people of poor action and reaction cannot be ignored for safety. It is apparent that when being braked, due to inertial effect, the power-driven wheelchair cannot be soon stopped but forward rush and then stop. Although such an inertial effect is quite low to people, it still threaten the old and may overturn or let the rider fall out of because of the rider's temporary carelessness.

Thus, to keep the power-driven to be braked stably and to enhance its moving safety are tasks to be dealt with immediately.

Consequently, in consideration of the problems caused by the conventional power-driven wheel in practical use, this inventor further improves it with comments and feedbacks given by the users of this product and finally successfully develops the safely assistant wheel structure of the power-driven wheelchair according to this invention after having made extraordinarily painstaking efforts to study diligently with a quiet mind for many years.

### SUMMARY OF THE INVENTION

Accordingly, it is a main object of this invention to provide a safely assistant wheel structure of a power-driven wheelchair, and with the support of assistant wheel, a forwarding leaning force, caused when the wheelchair is stopped, is eliminated for the stability of wheelchair body and the safe ride of a rider.

In order to achieve the object mentioned above, the power-driven wheelchair has a body under which a front wheel and a rear wheel are provided, in which a front end of the front wheel is provided with an assistant wheel of which an axle center is provided for a holder to stretch through above which a fixed link is provided stretching from the body, a shock absorber spring being provided between the holder and the fixed link. With the allocation above, when the moving power-driven wheelchair is suddenly braked, an inertial effect pushes the body to lean forward; however, with the support of assistant wheel, the forward leaning effect is eliminated and detracted by the spring for the stability of wheelchair body and the safe ride of a rider.

### BRIEF DESCRIPTION OF THE DRAWINGS

The drawings disclose an illustrative embodiment of the present invention which serves to exemplify the various advantages and objects hereof, and are as follows:

FIG. 1 is a 3D view of this invention.

FIG. 2 is a detailed view of a structure according to this invention.

### DETAILED DESCRIPTION OF THE PREFERRED EMBODIMENT

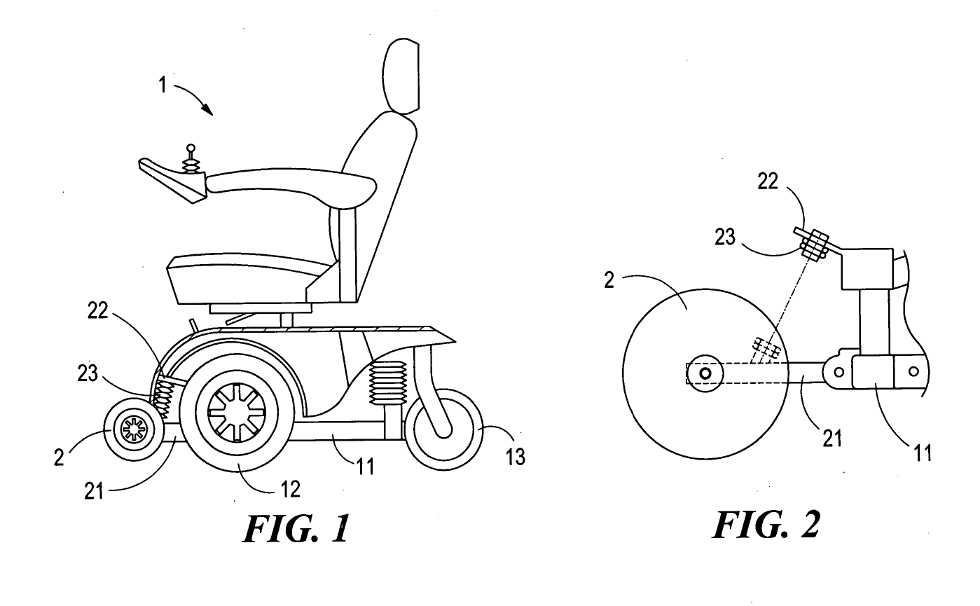

Referring now to FIGS. 1 and 2, this invention relates to a safely assistant wheel structure of a power-driven wheelchair. The power-driven wheelchair 1 has a body 11 under which a front wheel 12 and a rear wheel 13 are provided, in which a front end of the front wheel 11 is provided with an assistant wheel 2 of which an axle center is provided for a holder 21 to stretch through, the assistant wheel 2 being fixed with the holder 21 at a front end of the body 11. Thus, when the moving power-driven wheelchair 1 is suddenly braked, an inertial effect pushes the body 11 to lean forward; however, with the support of assistant wheel 2, the forward leaning effect is eliminated for the stability of wheelchair body 11 and the safe ride of a rider.

Further, with the stretching holder 21, the assistant wheel 2 is located the front end of the body 11 so that the assistant wheel 2, when being pressed with a force, may cause the holder 21 to vibrate and even to be damaged, and thereby a fixed link 22 is located on the holder 21; the fixed link 22 is provided stretching from the body 11 and a shock absorber spring 23 is provided between the holder 22 and the fixed link 21 to eliminate the forward leaning effect when the wheelchair is braked, for the purpose of the extensional service life of assistant wheel 2 and the increasing stability of power-driven wheelchair 1.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A safely assistant wheel structure of a power-driven wheelchair, characterized in that:
at the front end of a front wheel of the power-driven wheelchair, an assistant wheel is provided to prevent the forward moving wheelchair from forward leaning with an inertial effect when being braked for the purpose of the safety of a rider.

2. The safely assistant wheel structure of power-driven wheelchair according to claim 1, wherein a holder is provided stretching an axle center of the assistant wheel so as to be fixed onto the body of the power-driven wheelchair.

3. The safely assistant wheel structure of power-driven wheelchair according to claim 2, wherein a fixed link is provided stretching above the holder of the wheelchair and a shock absorber spring is provided between the holder and the fixed link.
